(19) United States
(12) Patent Application Publication
(10) Pub. No.: US 2020/0124846 A1
(43) Pub. Date: Apr. 23, 2020

(54) DISPLAY DEVICE

(71) Applicant: HONDA MOTOR CO., LTD., Tokyo (JP)

(72) Inventors: Masafumi Higashiyama, Wako-shi (JP); Takuya Kimura, Wako-shi (JP); Shinji Kawakami, Wako-shi (JP); Tatsuya Iwasa, Wako-shi (JP); Yuji Kuwashima, Wako-shi (JP)

(21) Appl. No.: 16/654,056

(22) Filed: Oct. 16, 2019

(30) Foreign Application Priority Data
Oct. 19, 2018 (JP) 2018-197949

(51) Int. Cl. G02B 27/01

(52) U.S. Cl. CPC G02B 27/0101

(57) ABSTRACT

A display device includes a light projection device configured to project light including an image, an optical member provided on a path of the light, and a concave mirror configured to reflect light passing through the optical member toward a reflector having optical transparency, wherein in an optical system including the optical member, the concave mirror, and the reflector, a focal length in a vertical direction is shorter than a focal length in a horizontal direction.

### CROSS-REFERENCE TO RELATED APPLICATION

Priority is claimed on Japanese Patent Application No. 2018-197949, filed Oct. 19, 2018, the content of which is incorporated herein by reference.

### BACKGROUND

### Field of the Invention

The present invention relates to a display device.

### Description of Related Art

In the related art, a head up display device (hereinafter referred to as an HUD (Head Up Display) device) that displays an image regarding basic information for a driver on a front windshield is known (Japanese Unexamined Patent Application, First Publication No. 2017-91115). Obstacles, alerts, and various marks indicating a traveling direction are superimposed on a landscape in front of a vehicle and displayed using the HUD device, allowing the driver to recognize various types of displayed information while keeping a direction of a line of sight at the time of driving as a forward direction.

### SUMMARY

However, in the related art, light is projected onto an object having optical transparency such as a front windshield so that an image is superimposed on a landscape and displayed, and a phenomenon called a double image in which two images having different luminances overlap each other occurs. In some cases, the visibility of the image is degraded.

The present invention has been made in view of such circumstances, and an object of the present invention is to provide a display device capable of improving the visibility of an image.

A display device according to the present invention adopts the following configuration.

(1) An aspect of the present invention is a display device including: a light projection device configured to project light including an image; an optical member provided on a path of the light; and a concave mirror configured to reflect light passing through the optical member toward a reflector having optical transparency, wherein in an optical system including the optical member, the concave mirror, and the reflector, a focal length in a vertical direction is shorter than a focal length in a horizontal direction.

(2) In the above aspect (1), the focal length in the vertical direction is 5 meters or less.

(3) In the above aspect (1), the focal length in the horizontal direction is 1.4 times or more the focal length in the vertical direction.

(4) In the above aspect (1), the focal length in the horizontal direction is 7 meters or more.

(5) Another aspect of the present invention is a display device including: a light projection device configured to project light including an image; an optical mechanism provided on a path of the light and capable of adjusting a distance from a predetermined position to a position at which the light is formed as a virtual image; a first actuator configured to adjust the distance in the optical mechanism; and a concave mirror configured to reflect light passing through the optical mechanism toward a reflector having optical transparency, wherein in an optical system including the optical mechanism, the concave mirror, and the reflector, a relationship in which a focal length in a vertical direction is shorter than a focal length in a horizontal direction is established at least when the distance adjusted by the optical mechanism is a shortest distance.

(6) In the above aspect (5), when the distance adjusted by the optical mechanism is the shortest distance, the focal length in the vertical direction is 5 meters or less.

(7) In the above aspect (5), when the distance adjusted by the optical mechanism is the shortest distance, the focal length in the horizontal direction is 1.4 times or more the focal length in the vertical direction.

(8) In the above aspect (5), when the distance adjusted by the optical mechanism is the shortest distance, the focal length in the horizontal direction is 7 meters or more.

According to the above aspects (1) to (8), it is possible to improve the visibility of an image.

### BRIEF DESCRIPTION OF THE DRAWINGS

FIG. 1 is a diagram illustrating a configuration of a vehicle cabin of a vehicle in which a display device according to an embodiment has been mounted.

FIG. 2 is a diagram illustrating an operation switch of the embodiment.

FIG. 3 is a partial configuration diagram of the display device.

FIG. 4 is a diagram illustrating an example of a virtual image in which a double image has been generated.

FIG. 5 is a diagram illustrating a configuration example of the display device mainly including a display control device.

FIG. 6 is a diagram schematically illustrating characteristics of an optical system in the display device.

### DESCRIPTION OF EMBODIMENTS

Hereinafter, an embodiment of a display device of the present invention will be described with reference to the drawings. The display device is a device that is mounted on a vehicle (hereinafter referred to as a vehicle M) and allows an image to be superimposed on a landscape and visually recognized. The display device is, for example, an HUD device. As an example, the display device is a device that allows a viewer to visually recognize a virtual image by projecting light including an image onto a front windshield of the vehicle M. The viewer is a driver of the vehicle M, for example. The present invention is not limited thereto, and the display device may allow a virtual image to be visually recognized by an occupant (for example, an occupant seated in a passenger seat) other than the driver.

Hereinafter, positional relationships or the like will be described by appropriately using an XYZ coordinate system. A Z direction indicates a vertical direction, an X direction indicates one direction in a horizontal plane orthogonal to the Z direction, and a Y direction indicates another direction in the horizontal plane. The Z direction indicates a height direction of the vehicle M, the X direction indicates a depth direction (a traveling direction) of the vehicle M, and the Y direction indicates a width direction of the vehicle M.

### [Overall Structure]

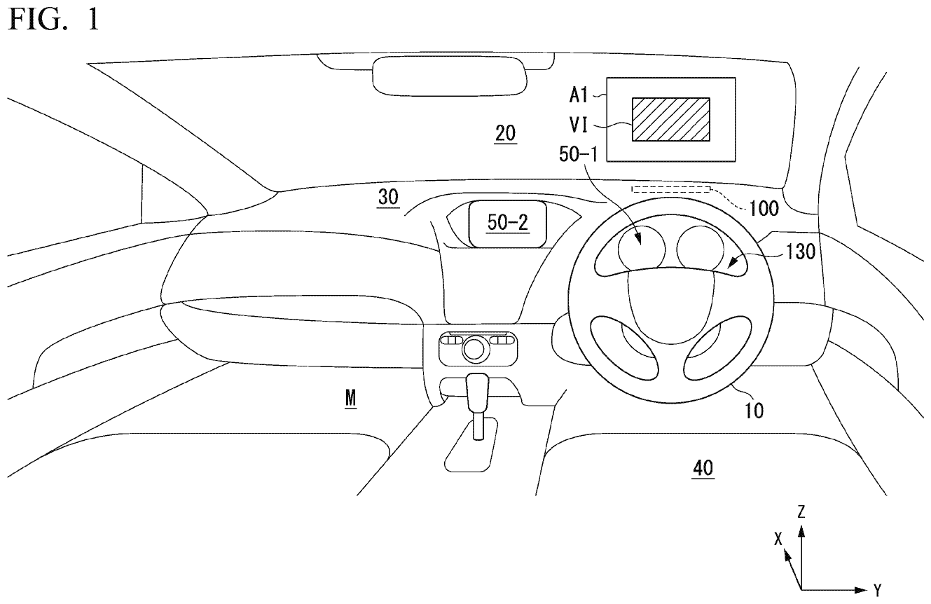

FIG. 1 is a diagram illustrating a configuration of a vehicle cabin of a vehicle M in which a display device 100 according to the embodiment is mounted. For example, a steering wheel 10 that controls steering of the vehicle M, a front windshield 20 that separates the outside of the vehicle from the vehicle cabin, and an instrument panel 30 are provided in the vehicle M. The front windshield 20 is a member having optical transparency. The display device 100, for example, projects light including an image onto a displayable area A1 provided in a part of the front windshield 20 in front of a driver's seat 40, thereby allowing a driver seated in the driver's seat to visually recognize a virtual image VI.

The display device 100, for example, allows the driver to visually recognize, as the virtual image VI, an image obtained by converting information for assisting in driving of the driver to an image. The information for assisting in the driving of the driver includes, for example, information such as a speed of the vehicle M, a driving force distribution ratio, an engine speed, an operation state shift position of a driving assistance function, a sign recognition result, and an intersection position. The driving assistance function includes, for example, an adaptive cruise control system (ACC), a lane keeping assistance system (LKAS), a collision mitigation brake system (CMBS), and a traffic jam assistance function.

A second display device 50-1 and a third display device 50-2 may be provided in the vehicle M, in addition to the display device 100. The second display device 50-1 is, for example, a display device that is provided in the vicinity in front of the driver's seat 40 in the instrument panel 30 and that the driver can visually recognize from a gap next to the steering wheel 10 or in the steering wheel 10. The third display device 50-2 is attached to, for example, a center portion of the instrument panel 30. The third display device 50-2 displays, for example, an image corresponding to a navigation process executed by a navigation device (not illustrated) mounted in the vehicle M or displays an image of another party in a videophone, or the like. The third display device 50-2 may display a television program, perform playback of a DVD, or display content such as a downloaded movie.

An operation switch 130 that receives an instruction to switch between ON and OFF of a display of the display device 100 or an instruction to adjust a position of the virtual image VI is provided in the vehicle M. The operation switch 130, for example, is attached at a position at which the driver seated in the driver's seat 40 can operate the operation switch 130 without greatly changing his or her posture. For example, the operation switch 130 may be provided in front of the second display device 50-1, may be provided in a protrusion (projection) portion of the instrument panel 30 in which the steering wheel 10 is provided, or may be provided in a spoke that connects the steering wheel 10 to the instrument panel 30.

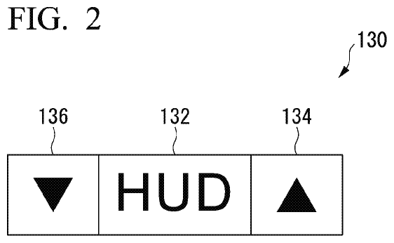

FIG. 2 is a diagram illustrating the operation switch 130 of the embodiment. The operation switch 130 includes, for example, a main switch 132, a first adjustment switch 134, and a second adjustment switch 136. The main switch 132 is a switch that switches between ON and OFF of the display device 100.

The first adjustment switch 134 is a switch that receives an operation for moving the position of the virtual image VI upward (hereinafter referred to as an upward direction) in a vertical direction Z. The virtual image VI is, for example, a virtual image that is visually recognized through the front windshield 20 onto which the image has been projected in a state in which the driver is seated in the driver's seat 40. The virtual image VI is displayed in the displayable area A1 as if the virtual image VI were present in a space outside the vehicle that has been transmitted through the front windshield 20 when the driver views the displayable area A1 from a line-of-sight position P1 of the driver to be described below. The driver, for example, can continuously move a visual recognition position of the virtual image VI in the displayable area A1 in an upward direction by continuously pressing the first adjustment switch 134.

The second adjustment switch 136 is a switch that receives an operation for moving the position of the virtual image VI downward (hereinafter referred to as a downward direction) in the vertical direction Z. The driver can continuously move the visual recognition position of the virtual image VI in the displayable area A1 downward by continuously pressing the second adjustment switch 136.

The first adjustment switch 134 may be a switch that receives an operation for increasing a luminance of the virtual image VI instead of (or in addition to) moving the position of the virtual image VI in a upward direction. The second adjustment switch 136 may be a switch that receives an operation for decreasing the luminance of the virtual image VI to be visually recognized, instead of (or in addition to) moving the position of the virtual image VI downward. Contents of instructions received by the first adjustment switch 134 and the second adjustment switch 136 may be switched between on the basis of any operation. The operation is, for example, a long pressing operation of the main switch 132. The operation switch 130 may include, for example, a switch that receives an operation for selecting display content or a switch that receives an operation for adjusting the luminance of the virtual image VI, in addition to the switches illustrated in FIG. 2.

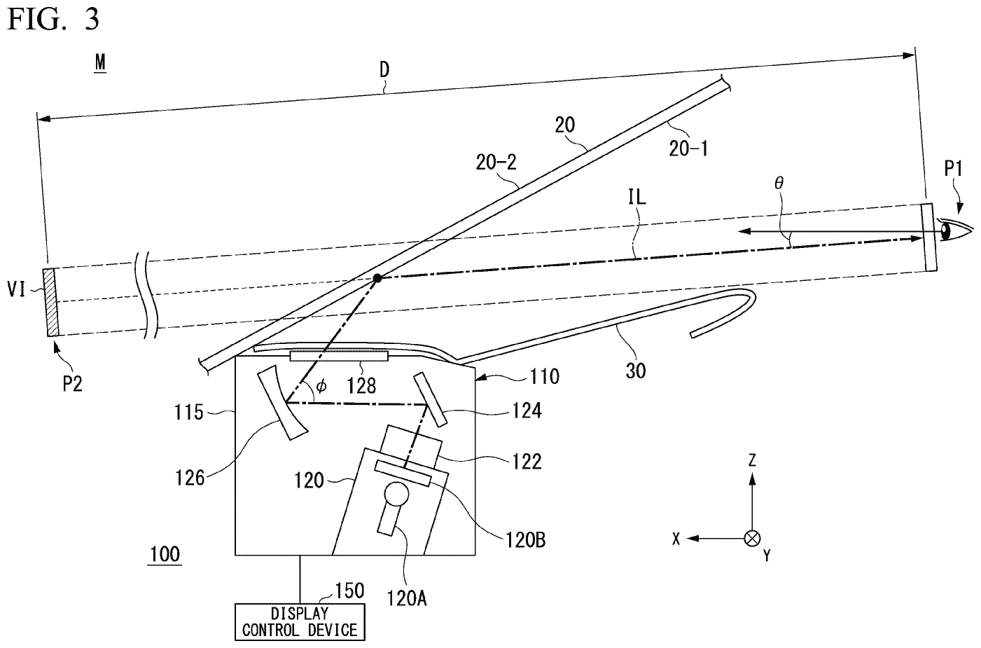

FIG. 3 is a partial configuration diagram of the display device 100. The display device 100 includes, for example, a display device 110 and a display control device 150. The display device 110 accommodates, for example, a light projection device 120, an optical mechanism 122, a plane mirror 124, a concave mirror 126, and a light transmission cover 128 in a casing 115. In addition to these, the display device 100 includes various sensors or actuators, which will be to be described below.

The light projection device 120 includes, for example, a light source 120A and a display element 120B. The light source 120A is, for example, a cold cathode tube or a light emitting diode, and outputs visible light corresponding to the virtual image VI that is visually recognized by the driver. The display element 120B controls transmission of the visible light from the light source 120A. The display element 120B is, for example, a thin film transistor (TFT) type liquid crystal display device (LCD). The display element 120B controls each of a plurality of pixels to control a degree of transmission of each color element of the visible light from the light source 120A, thereby causing image elements to be included in the virtual image IV and determining a display aspect (appearance) of the virtual image IV. Hereinafter, the visible light that is transmitted through the display element 120B and in which an image is included is referred to as image light IL. The display element 120B may be an organic electroluminescence (EL) display. In this case, the light source 120A may be omitted.

An optical mechanism 122 includes, for example, one or more lenses. A position of each lens can be adjusted in an optical axis direction, for example. The optical mechanism 122 is provided, for example, on a path of the image light IL output by the light projection device 120, transmits the image light IL incident from the light projection device 120, and emits the image light IL toward the front windshield 20. In the optical mechanism 122, for example, the position of the lens is changed such that a distance from the line-of-sight position P1 of the driver to a formation position at which the image light IL is formed as the virtual image VI (an image formation position at which the image light IL is formed as the virtual image VI) P2 (hereinafter referred to as virtual image visual recognition distance D) can be adjusted. The line-of-sight position P1 of the driver is a position on which the image light IL reflected by the concave mirror 126 and the front windshield 20 is concentrated, and is a position at which an eye of the driver is assumed to be present. Strictly speaking, the virtual image visual recognition distance D is a distance of a line segment having a slope in a vertical direction, but when the “virtual image visual recognition distance D is expressed as, for example, 7 [m]” in the following description, the distance may mean a distance in a horizontal direction.

The plane mirror 124 reflects the visible light (that is, the image light IL) emitted from the light source 120A and passing through the display element 120B toward the concave mirror 126.

The concave mirror 126 reflects the image light IL incident from the plane mirror 124 toward the front windshield 20. The concave mirror 126 is supported to be rotatable (revolvable) around a Y axis that is the width direction of the vehicle M.

The light transmission cover 128 is a member having optical transparency and is formed of, for example, a synthetic resin such as plastic. The light transmission cover 128 is provided to cover an opening formed in an upper surface of the casing 115. An opening or a member having optical transparency is also provided in the instrument panel 30. Accordingly, the image light IL reflected by the concave mirror 126 can be transmitted through the light transmission cover 128 and incident on the front windshield 20. Further, foreign matter such as dust, dirt, and water droplets are prevented from entering the casing 115.

The image light IL incident on the front windshield 20 is reflected by the front windshield 20 and is concentrated on the line-of-sight position P1 of the driver. In this case, when the eye of the driver is located at the line-of-sight position P1 of the driver, the driver feels as if the image projected by the image light IL is displayed in front of the vehicle M.

A mechanism of a general double image will be described herein. For convenience, description will be made using the names and symbols of respective portions of the embodiment as they are. When the image light IL reflected by the concave mirror 126 is incident on the front windshield 20, the image light IL is reflected by each of a front surface (a surface on the inner side of the vehicle) 20-1 and a rear surface (a surface on the outer side of the vehicle) 20-2 of the front windshield 20 since the front windshield 20 having a certain thickness has optical transparency. In this case, a part of the virtual image VI (hereinafter referred to as a first virtual image VI₁) of the image light IL reflected by the front surface 20-1 of the front windshield 20 and a part of the virtual image VI (hereinafter referred to as a second virtual image VI₂) of the image light IL reflected by the rear surface 20-2 of the front windshield 20 overlap each other with a positional shift. The first virtual image VI₁ and second virtual image VI₂ overlapping each other can be visually recognized as a double image by the driver.

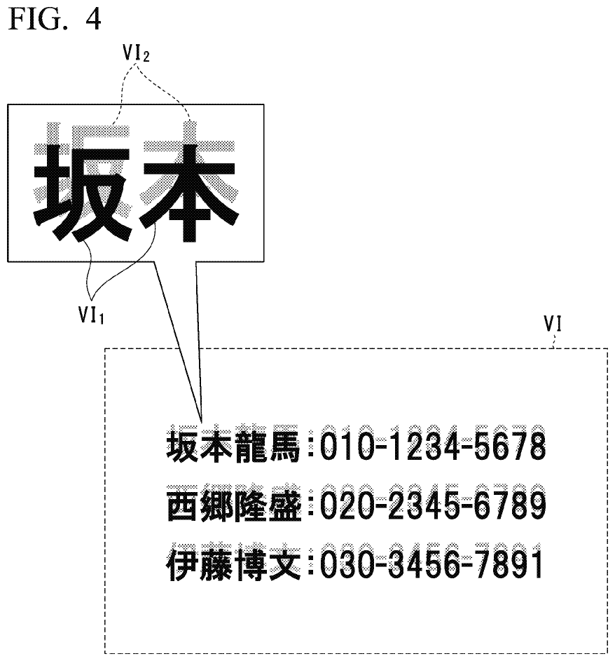

FIG. 4 is a diagram illustrating an example of the virtual image VI in which a double image is generated. As illustrated, for example, when an image including letters or the like is output as the image light IL by the light projection device 120, the image light IL reflected by the front surface 20-1 of the front windshield 20 is concentrated on the line-of-sight position P1 of the driver and the first virtual image VI₁ is formed, and the image light IL reflected by the rear surface 20-2 of the front windshield 20 is concentrated on the line-of-sight position P1 of the driver and the second virtual image VI₂ is formed. As illustrated in FIG. 3, the image light IL reflected by the concave mirror 126 is incident on the front windshield 20 tilted in the horizontal direction (the X direction) from below, and therefore, a reflection point of the image light IL on the rear surface 20-2 of the front windshield 20 is located above a reflection point of the image light IL on the front surface 20-1. As a result, the second virtual image VI₂ is formed with an upward shift from the first virtual image VI₁. The second virtual image VI₂ has a lower luminance than the first virtual image VI₁ due to a difference in refractive index between the air in the vehicle cabin and the front windshield 20. That is, the second virtual image VI₂ is displayed with a more transparent background than the first virtual image VI₁.

On the other hand, in the display device 100 of the embodiment, an optical system including the optical mechanism 122, the concave mirror 126, and the front windshield 20 is configured so that a relationship in which a focal length in the vertical direction is shorter than a focal length in the horizontal direction is established at least when the virtual image visual recognition distance D is a shortest distance Dmin, thereby relieving a degree to which a double image is recognized by the viewer. Details will be described after the display control device 150 is described.

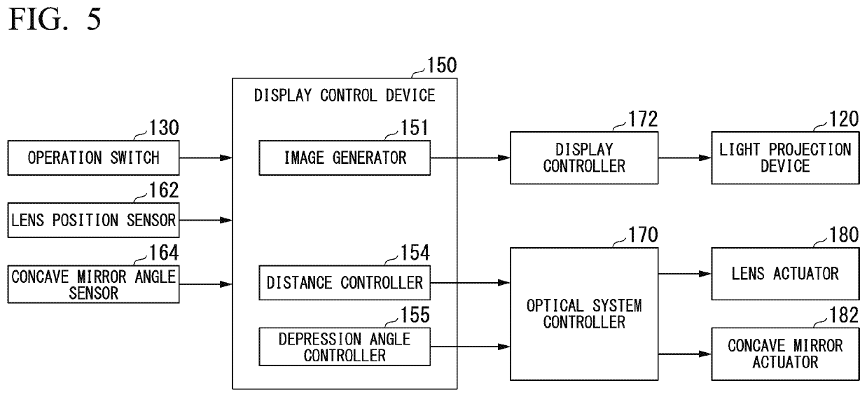

The display control device 150 controls a display of the virtual image VI that is visually recognized by the driver. FIG. 5 is a diagram illustrating a configuration example of the display device 100 mainly including the display control device 150. In the example of FIG. 5, the light projection device 120, the operation switch 130, a lens position sensor 162, a concave mirror angle sensor 164, an optical system controller 170, a display controller 172, a lens actuator (an example of a first actuator) 180, and a concave mirror actuator 182 are illustrated, in addition to the display control device 150. First, each component other than the display control device 150 will be described.

The lens position sensor 162 detects positions of the one or more lenses included in the optical mechanism 122. The concave mirror angle sensor 164 detects a rotation angle of the concave mirror 126 around the Y axis.

The optical system controller 170 drives the lens actuator 180 on the basis of a control signal output by the display control device 150 to adjust the virtual image visual recognition distance D. The virtual image visual recognition distance D can be adjusted, for example, in a range of several meters to tens or more meters (or tens of meters). Hereinafter, a lower limit of the adjustable range is indicated by the shortest distance Dmin, and an upper limit is indicated by a longest distance Dmax. The optical system controller 170 drives the concave mirror actuator 182 to adjust a reflection angle ϕ of the concave mirror on the basis of a control signal output by the display control device 150.

The display controller 172 allows the light projection device 120 to project light including an image based on a control signal supplied from the image generator 151.

The lens actuator 180 acquires a driving signal from the optical system controller 170 and drives a motor or the like on the basis of the acquired driving signal to move a position of one or more lenses included in the optical mechanism 122. Accordingly, the virtual image visual recognition distance D is adjusted.

The concave mirror actuator 182 acquires a driving signal from the optical system controller 170, and drives a motor or the like on the basis of the acquired driving signal to rotate the concave mirror actuator 182 around the Y axis and adjust the reflection angle ϕ of the concave mirror 126. Accordingly, a depression angle θ is adjusted.

The display control device 150 includes, for example, an image generator 151, a distance controller 154, and a depression angle controller 155. These components are realized, for example, by a hardware processor such as a central processing unit (CPU) executing a program (software). Some or all of the components may be realized by hardware (including circuitry) such as a large scale integration (LSI), an application specific integrated circuit (ASIC), a field-programmable gate array (FPGA), or a graphics processing unit (GPU) or may be realized by software and hardware in cooperation. The program may be stored in a storage device such as an HDD or a flash memory in advance or may be stored in a removable storage medium such as a DVD or a CD-ROM and the storage medium may be mounted in a drive device so that the program may be installed. Division of the components of the display control device 150 is for convenience only and does not mean that the software and the hardware are clearly separated as illustrated.

The image generator 151 generates an image. “Generate” is a convenient expression and may simply refer to an operation of reading image data from a storage and outputting the image data to the display controller 172. The image generator 151 generates, for example, an image for allowing the driver to recognize the speed of the vehicle M, the driving force distribution ratio, the engine speed, an operation state of the driving assistance function, the shift position, and the like. The image generator 151 may generate an image according to an event occurring in the vehicle M (for example, an output of lane change guidance by a navigation device).

The distance controller 154 outputs a control signal for adjusting the virtual image visual recognition distance D to the optical system controller 170. For example, the distance controller 154 increases the virtual image visual recognition distance D as the speed of the vehicle M increases, and decreases the virtual image visual recognition distance D as the speed of the vehicle M decreases. This is in line with the fact that the driver tends to visually recognize far away as the speed increases. Since the speed is zero when the vehicle M is stopped, the distance controller 154 adjusts the virtual image visual recognition distance D to the shortest distance Dmin.

The depression angle controller 155 outputs a control signal for adjusting the reflection angle of the concave mirror 126 to the optical system controller 170. For example, the depression angle controller 155 adjusts the reflection angle ϕ on the basis of an operation with respect to the operation switch 130. The depression angle controller 155 decreases the reflection angle to decrease the depression angle θ as the virtual image visual recognition distance D increases.

The virtual image VI is an image displayed on the display element 120B enlarged or reduced according to the virtual image visual recognition distance D. When the virtual image visual recognition distance D is variable, the driver can visually recognize virtual images VI having different sizes even when images (display areas) displayed on the display element 120B have the same size. Therefore, the image generator 151 outputs, to the display controller 172, a control signal for causing an image having a size according to the virtual image visual recognition distance D to be displayed on the display element 120B so that the size of the virtual image VI to be visually recognized by the driver is kept constant even when the virtual image visual recognition distance D has been changed.

Hereinafter, the characteristics of the optical system including the optical mechanism 122, the concave mirror 126, and the front windshield 20 in the display device 100 will be described again. As described above, in this optical system, the relationship in which the focal length in the vertical direction is shorter than the focal length in the horizontal direction is established at least when the virtual image visual recognition distance D is the shortest distance Dmin. Such a configuration is adopted because a double image is most troublesome for the viewer when the virtual image visual recognition distance D is the shortest distance Dmin.

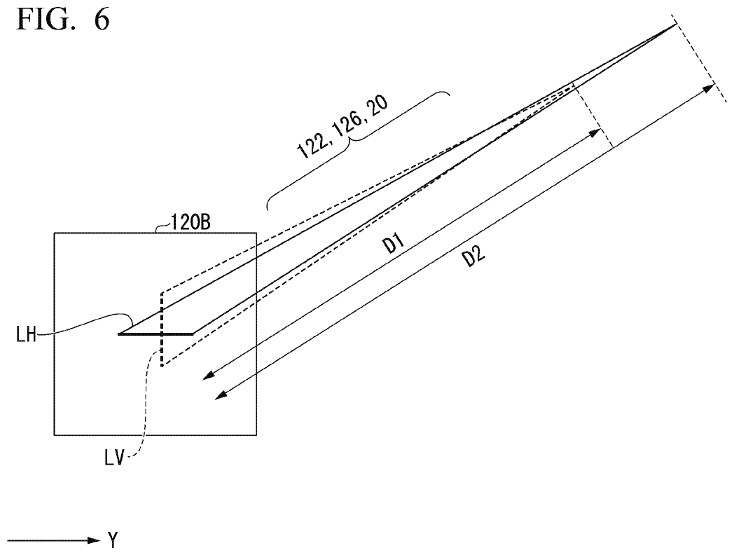

FIG. 6 is a diagram schematically illustrating characteristics of the optical system in the display device 100. As illustrated, among lines displayed by pixels arranged in a matrix shape, a honeycomb shape, or the like in the display element 120B, a distance D1 at which a vertical line LV is clearly visible is shorter than a distance D2 at which a horizontal line VH is clearly visible. Here, the horizontal line is a line drawn in a horizontal direction, that is, the Y direction in FIGS. 1 and 3, and the vertical line is a line drawn in a vertical direction, that is, an arbitrary direction orthogonal to the Y direction (for example, an X-direction component and a Z-direction component are included). The distance D1 and the distance D2 are distances starting from a center point of the entire display element 120B.

The optical system is configured such that the distance D1 is, for example, 5 meters or less and the distance D2 is, for example, 7 meters or more when the virtual image visual recognition distance D is adjusted to the shortest distance Dmin. As a result, the distance D2 is 1.4 times or more the distance D1. Accordingly, since a double image is more recognizable compared with a case in which the optical system is not configured in this way, a degree to which a double image is troublesome is suppressed such that the visibility of the image can be improved.

According to the knowledge obtained through experiments by the inventors of the present application, the first virtual image VI₁ that is originally desired to be recognized is recognized at a position according to the focal length in the vertical direction, and the second virtual image VI₂ that is not desired to be recognized is recognized at a position according to a focal length in the horizontal direction. Therefore, it is possible to relieve an influence of a double image by making the position of the second virtual image VI₂ distant from the viewer. However, since the clearness of the virtual image VI is lost when the second virtual image VI₂ is too far away, it is preferable for the distance D2 to be set to be 1.4 times or more the distance D1 and not to greatly exceed 1.4 times (to be, for example, 1.7 times or less) the distance D1.

A difference between the distance D1 and the distance D2, for example, increases as the virtual image visual recognition distance D increases, but does not increase in proportion to the virtual image visual recognition distance D. As a result, a magnification between the distance D2 and the distance D1 may decrease as the virtual image visual recognition distance D increases.

According to the embodiment described above, in the optical system including the optical mechanism 122, the concave mirror 126, and the front windshield 20, the relationship in which the focal length in the vertical direction is shorter than the focal length in the horizontal direction is established. Accordingly, it is possible to improve the visibility of an image.

The display device 100 may be a display device including no distance changing mechanism, that is, a display device in which the optical mechanism 122 is a fixed optical member and the lens actuator 180 is not included. In this case, the virtual image visual recognition distance D is constant, and a relationship between the distances D1 and D2 described above is always established.

The display device 100 may project an image onto a combiner provided on the front side of the front windshield 20 when viewed from the driver, instead of directly projecting the image onto the front windshield 20. The combiner is a member having optical transparency, such as a transparent plastic disc. The combiner is another example of a “reflector”.

The display device 100 may project light onto a display device having optical transparency attached on a side in front of, front surface, or inside of the front windshield 20, instead of projecting the light onto the front windshield 20. Examples of the display device having optical transparency include a liquid crystal display and an organic EL display. The display device may project light onto a transparent member (for example, a visor or a lens of eyeglasses) included in a device worn on a body of a person.

Although a mode for carrying out the present invention has been described above using the embodiment, the present invention is not limited to the embodiment at all, and various modifications and substitutions may be made without departing from the spirit of the present invention.

What is claimed is:

1. A display device comprising:
a light projection device configured to project light including an image;
an optical member provided on a path of the light; and
a concave mirror configured to reflect light passing through the optical member toward a reflector having optical transparency,
wherein in an optical system including the optical member, the concave mirror, and the reflector, a focal length in a vertical direction is shorter than a focal length in a horizontal direction.

2. The display device according to claim 1,
wherein the focal length in the vertical direction is 5 meters or less.

3. The display device according to claim 1,
wherein the focal length in the horizontal direction is 1.4 times or more the focal length in the vertical direction.

4. The display device according to claim 1,
wherein the focal length in the horizontal direction is 7 meters or more.

5. A display device comprising:
a light projection device configured to project light including an image;
an optical mechanism provided on a path of the light and capable of adjusting a distance from a predetermined position to a position at which the light is formed as a virtual image;
a first actuator configured to adjust the distance in the optical mechanism; and
a concave mirror configured to reflect light passing through the optical mechanism toward a reflector having optical transparency,
wherein in an optical system including the optical mechanism, the concave mirror, and the reflector, a relationship in which a focal length in a vertical direction is shorter than a focal length in a horizontal direction is established at least when the distance adjusted by the optical mechanism is a shortest distance.

6. The display device according to claim 5,
wherein when the distance adjusted by the optical mechanism is the shortest distance, the focal length in the vertical direction is 5 meters or less.

7. The display device according to claim 5,
wherein when the distance adjusted by the optical mechanism is the shortest distance, the focal length in the horizontal direction is 1.4 times or more the focal length in the vertical direction.

8. The display device according to claim 5,
wherein when the distance adjusted by the optical mechanism is the shortest distance, the focal length in the horizontal direction is 7 meters or more.
